(19) United States
(12) Patent Application Publication
(10) Pub. No.: US 2021/0129234 A1
(43) Pub. Date: May 6, 2021

(54) Core Bit Having a Spiral-Tube-Shaped Drill Shaft, and Method for Producing a Spiral-Tube-Shaped Drill Shaft for a Core Bit

(71) Applicant: Hilti Aktiengesellschaft, Schaan (LI)

(72) Inventors: Florian SCHROEDER, Maienfeld (CH); Roland SCHNEIDER, Schlins (AT); Christoph WEBER, Oberaegeri (CH)

(73) Assignee: Hilti Aktiengesellschaft, Schaan (LI)

(21) Appl. No.: 16/472,733

(22) PCT Filed: Nov. 28, 2017
(86) PCT No.: PCT/EP2017/080661

§ 371 Date: Jun. 21, 2019

(30) Foreign Application Priority Data
Dec. 23, 2016 (EP) 16206536.1

(51) Int. Cl. B23B 51/04; B23K 31/02

(52) U.S. Cl. CPC B23B 51/0406; B23K 31/027; B23K 2101/20; B23B 2240/16; B23B 2240/04

(57) ABSTRACT

A core bit for producing a borehole in a workpiece includes a cutting portion with one or more cutting segments, a drill shaft portion with a tubular drill shaft, and a connecting device which connects the cutting portion and the drill shaft portion releasably or non-releasably together. The tubular drill shaft is configured as a welded spiral tube.

### CROSS REFERENCE TO RELATED APPLICATIONS

This application claims the priority of International Application No. PCT/EP2017/080661, filed Nov. 28, 2017, and European Patent Document No. 16206536.1, filed Dec. 23, 2016, the disclosures of which are expressly incorporated by reference herein.

### BACKGROUND AND SUMMARY OF THE INVENTION

The invention relates to a core bit having a spiral-tube-shaped drill shaft and a method for producing a spiral-tube-shaped drill shaft for such a core bit.

Core bits consist of core bit portions configured as a cutting portion and a drill shaft portion. The cutting portion comprises a ring portion and one or more cutting segments that are welded, soldered or screwed to the ring portion or fixed to the ring portion by another suitable method of attachment. The drill shaft portion comprises a tubular drill shaft, a cover and an insertion end, by means of which insertion end the core bit is fixed in the tool holder of a core drill. The drill shaft is made from a tubular material or from a flat strip material that is shaped into a tube and joined at the strip edges by means of longitudinal welding. The cutting portion and the drill shaft portion are releasably or non-releasably connected by means of a connecting device. In the case of core bits with a non-releasable connecting device between the cutting portion and the drill shaft portion, the ring portion of the cutting portion and of the drill shaft may be configured monolithically, or alternatively the ring portion may be integrally connected to the drill shaft.

During drilling, a core bit produces a drilled core having a core diameter and a borehole having a borehole diameter in a workpiece. The cutting segments form a cutting ring having an inner diameter that corresponds to the core diameter and an outer diameter that corresponds to the borehole diameter. In drilling, a distinction is made between wet drilling and dry drilling. Core bits for wet drilling (wet core bits) differ in structure from core bits for dry drilling (dry core bits). Wet drilling requires a cooling and flushing fluid, which, as a cooling fluid, cools the cutting segments of the core bit and, as a flushing fluid, removes drilling cuttings from the borehole. Clean cooling and flushing fluid is generally added through an inner gap between the drilled core and the drill shaft and used cooling and flushing fluid mixed with drilling cuttings is removed through an outer gap between the drill shaft and the borehole.

Wet core bits that have both an inner gap between the drilled core and the drill shaft and an outer gap between the drill shaft and the borehole are guided solely by the cutting portion during drilling, there is no guidance of the drill shaft as a whole. The lack of guidance of the drill shaft can result in unwanted movements of the core bit during drilling, which impair the quality of the borehole. The stronger the movements of the core bit, the more strongly the geometry of the borehole may deviate from a circular shape. In addition, elastic deformations of the drill shaft may occur as a result of the force applied by the drilled core or of the borehole on the drill shaft.

To improve the guidance of a wet core bit, core bits without an inner gap and/or without an outer gap are known, wherein the cooling and flushing fluid is transported via special transport channels in the outside of the drill shaft. This has the disadvantage that the drill shaft has a large contact surface with the drilled core on the inside and a large contact surface with the borehole on the outside. The large contact surfaces on the inside and outside of the drill shaft produce strong friction. The greater the friction between the drill shaft and the drilled core and/or the drill shaft and the borehole, the slower the drilling progress of the core bit for the same output of the core drill and the shorter the lifespan of the drill shaft.

The object of the present invention is to further develop a core bit such that the stability and the guidance of the drill shaft during drilling, particularly during wet drilling with a cooling and flushing fluid, are improved. In addition, the drilling progress of the core bit should be increased, and/or the lifespan of the drill shaft extended.

In the invention, the core bit is characterized in that the tubular drill shaft is configured as a welded spiral tube, where a drill shaft configured as a welded spiral tube is also referred to as a spiral-tubular drill shaft. A welded spiral tube has at least one spiral-shaped connection weld that acts as a stiffening member for the drill shaft and increases the stiffness of the drill shaft compared to a longitudinally seam-welded or tubular drill shaft having the same wall thickness. Alternatively, strip materials with lower wall thicknesses, which in the finished drill shaft are as stiff as a longitudinally seam-welded or tubular drill shaft, can be used. Thus, using a welded spiral tube as a drill shaft either increases the stiffness of the drill shaft during drilling and/or reduces the weight of the drill shaft. A drill shaft with a higher degree of stiffness improves the stability of the drill shaft during drilling.

The core bit according to the invention has a cutting portion with one or more cutting segments, a drill shaft portion with the spiral-tube-shaped drill shaft and a connecting device that connects the cutting portion and the drill shaft portion releasably or non-releasably together. The cutting portion comprises a single cutting segment that forms a closed cutting ring, or a plurality of cutting segments that are arranged in a ring and form a cutting ring with intermediate spaces. In the case of core bits having a cutting portion that is releasably connected to the drill shaft portion, in addition to the cutting segments the cutting portion also comprises a ring portion that can be configured in a spiral-tube shape or in a tubular shape. The connecting device is configured as a releasable or non-releasable connecting device. A connecting device is described as being releasable if the connection can be released by the user without causing any destruction, for example, a plug connection, a pin connection or a threaded connection. A connecting device is described as being non-releasable if the user can release the connection only by causing destruction to the means of connection, for example, a soldered joint, a welded joint or a bonded joint.

The tubular drill shaft is preferably shaped from N, N≥1 strip materials, wherein the strip edges of the strip materials are integrally joined by means of N, N≥1 spiral-shaped connection welds. The drill shaft is made from one strip material (N=1) or a plurality of strip materials (N≥2), wherein the number of the strip materials used matches the number of the spiral-shaped connection welds. In the production of the spiral-tube-shaped drill shafts, the strip materials are continuously spirally shaped into spiral tubes having a constant radius of curvature in a molding plant and welded at the strip edges in a welding plant. For the production of the spiral tubes, methods using combined molding and welding plants and methods using separate molding and welding plants are known.

In a first variant, the N, N≥1 strip materials are configured as flat sheets having a constant sheet thickness. The spiral-tubular drill shaft is produced from flat sheets that have a constant sheet thickness and a constant width. The flat sheets are shaped into a spiral tube and integrally joined together at the strip edges by means of spiral-shaped connection welds. The shaped strip material has a constant wall thickness that corresponds to the sheet thickness of the flat sheets. The geometry of the spiral-shaped connection welds can be influenced by process control during welding. The addition of a seam material enables spiral-shaped connection welds to be produced that protrude on the inside of the drill shaft, or on the outside of the drill shaft, or on the inside and outside of the drill shaft, relative to the shaped strip material.

In a second variant, the N, N≥1 strip materials are configured as flat sheets having at least one recess. The recesses are produced in the sheet before the shaping of the strip material into the spiral tube and serve as a transport channel for the necessary cooling and flushing fluid during wet drilling. Wet drilling with a core bit requires a cooling and flushing fluid, which as a cooling fluid cools the cutting segments and as a flushing fluid removes drilling cuttings from the drilled hole. The number of recesses, the geometry of the recesses and the placement of the recesses on the inside and/or outside of the drill shaft can be adjusted according to the quantity of the cooling and flushing fluid. The recesses provided on the inside of the drill shaft are used for the addition of clean cooling and flushing fluid, and the recesses provided on the outside of the drill shaft are used for the removal of used cooling and flushing fluid mixed with drilling cuttings. Since the recesses in the core bit according to the invention are produced before the shaping of the strip material, recesses can be produced on the inside of the drill shaft with low manufacturing costs. In known drill shafts, the placement of transport channels on the outside of the drill shaft is limited, since in the case of a tubular drill shaft recesses can only be produced on the inside of the drill shaft with high manufacturing costs.

In a third variant, the N, N≥1 strip materials are configured as profiled sheets with a profiled cross-section, wherein the profiled sheets have a sheet thickness and a profiled height. The spiral-tube-shaped drill shaft is produced from plate-shaped profiled sheets. The longitudinal direction of the plate-shaped profiled sheets is defined to be the direction in which the profiled cross-section runs. Plate-shaped profiled sheets are available with various profiled cross-sections at a favorable cost and in a large number and enable the cost-effective production of drill shafts for core bits. The profiled cross-section produces recesses on the inside and outside of the drill shaft by means of which the cooling and flushing fluid can be transported. The recesses provided on the inside of the drill shaft are used to add clean cooling and flushing fluid and the recesses provided on the outside of the drill shaft are used for the removal of used cooling and flushing fluid mixed with drilling cuttings. The geometry of the profiled sheet can be adjusted according to the quantity of cooling and flushing fluid needed.

In a preferred further development of the core bit, at least one spiral-shaped connection weld of the drill shaft protrudes relative to the shaped strip material of the spiral tube, where the at least one protruding spiral-shaped connection weld contains a seam material. A spiral-shaped connection weld protruding relative to the shaped strip material of the spiral tube improves the guidance of the drill shaft during drilling. The protrusion of the spiral-shaped connection weld is adjusted in such a way that the spiral-shaped connection weld is in contact with the drilled hole on the outside of the drill shaft and/or in contact with the drilled core on the inside of the drill shaft. As a result of the protruding spiral-shaped connection weld, the drill shaft has a small contact surface with the drilled core and with the borehole and produces low friction. The lower the friction on the inside between the drill shaft and the drilled core and/or on the outside between the drill shaft and the borehole, the greater the drilling progress of the core bit for equal output of the core drill, and the lifespan of the drill shaft is increased. The spiral-shaped connection weld can protrude on an inside of the drill shaft, an outside of the drill shaft, or an inside and an outside of the drill shaft relative to the shaped strip material of the spiral tube. A seam material is required in order to produce a protrusion of the spiral-shaped connection weld. The seam material can be in the form of wire, strips or powder.

In addition to improved guidance of the drill shaft during wet and dry drilling, a spiral-shaped connection weld that protrudes relative to the shaped strip material of the spiral tube may improve the transportation of cooling and flushing fluid during wet drilling. The protruding spiral-shaped connection weld acts as a conveyor screw for the cooling and flushing fluid. In this regard, it should be noted that the protruding spiral-shaped connection weld can improve the transportation of the fluid on the inside or the outside of the drill shaft. On the inside of the drill shaft, clean cooling and flushing fluid is transported to the machining point, and on the outside of the drill shaft, used cooling and flushing fluid mixed with drilling cuttings is removed. The spiral-shaped connection weld acts as a conveyor screw for the clean cooling and flushing fluid if the direction of rotation of the core bit and the orientation of the spiral-shaped connection weld on the inside of the drill shaft coincide, and the spiral-shaped connection weld acts as a conveyor screw for the used cooling and flushing fluid mixed with drilling cuttings if the direction of rotation of the core bit and the orientation of the spiral-shaped connection weld on the outside of the drill shaft coincide.

In a preferred variant, the seam material and the N, N≥1 strip materials have the same material properties. If the seam material and the strip materials have the same material properties, this results in a smooth transition when welding the strip edges and the seam material can bind well with the strip material.

In an alternative preferred variant, the seam material and the N, N≥1 strip materials have different material properties, where the seam material has a higher tensile strength, a higher wear resistance, or a higher tensile strength and wear resistance than the strip materials. In the case of a spiral-shaped connection weld that protrudes relative to the shaped strip material, the connection weld should enable the drill shaft to be guided during drilling. The smaller the gap between the spiral-shaped connection weld and the drilled core on the inside of the drill shaft and/or between the spiral-shaped connection weld and the borehole on the outside, the better the drill shaft is guided. Friction between the spiral-shaped connection weld and the drilled core on the inside and/or between the spiral-shaped connection weld and the borehole on the outside may cause the spiral-shaped connection weld to become worn, as a result of which the guidance of the drill shaft is impaired. Using seam material that has a higher tensile strength, a higher wear resistance, or a higher tensile strength and wear resistance than the strip materials enables the properties of the spiral-shaped connection weld to be influenced so that guidance of the drill shaft by the spiral-shaped connection weld is ensured as far as possible throughout the whole lifespan of the drill shaft.

In a first preferred variant, the at least one protruding spiral-shaped connection weld protrudes on an inside of the drill shaft with an inner protrusion Δ_{I} relative to the shaped strip material of the spiral tube. A spiral-shaped connection weld protruding on the inside of the drill shaft enables the drill shaft to be guided by the drilled core when drilling with the core bit. In addition, a spiral-shaped connection weld protruding on the inside of the drill shaft may facilitate the transportation of clean cooling and flushing fluid to the machining point during wet drilling with the core bit. The spiral-shaped connection weld acts as a conveyor screw for the clean cooling and flushing fluid if the direction of rotation of the core bit and the orientation of the spiral-shaped connection weld on the inside of the drill shaft coincide.

In a second preferred variant, the at least one protruding spiral-shaped connection weld protrudes on an outside of the drill shaft with an outer protrusion Δ_{A} relative to the shaped strip material of the spiral tube. A spiral-shaped connection weld protruding on the outside of the drill shaft enables the drill shaft to be guided by the borehole during drilling with the core bit. In addition, a spiral-shaped connection weld protruding on the outside of the drill shaft may facilitate the removal of the used cooling and flushing fluid mixed with drilling cuttings during wet drilling with the core bit. The spiral-shaped connection weld acts as a conveyor screw for the used cooling and flushing fluid mixed with drilling cuttings if the direction of rotation of the core bit and the orientation of the spiral-shaped connection weld on the outside of the drill shaft coincide.

In a third preferred variant, the at least one spiral-shaped connection weld protrudes on an inside of the drill shaft with an inner protrusion Δ_{I} and on an outside of the drill shaft with an outer protrusion Δ_{A} relative to the shaped strip material of the spiral tube. During drilling with the core bit, a spiral-shaped connection weld protruding on the inside and outside of the drill shaft enables the drill shaft to be guided both by the drilled core on the inside of the drill shaft and by the borehole on the outside of the drill shaft. The spiral-shaped connection weld protruding on the inside and outside of the drill shaft acts as a conveyor screw for the cooling and flushing fluid during wet drilling on the inside or outside of the drill shaft. The orientation of the joining weld seam determines whether the spiral-shaped connection weld facilitates the transportation of the fluid on the inside or outside of the drill shaft. If the orientation of the spiral-shaped connection weld and the direction of rotation of the core bit on the inside of the drill shaft coincide, the spiral-shaped connection weld facilitates the transportation of the fluid on the inside of the drill shaft. If the orientation of the spiral-shaped connection weld and the direction of rotation of the core bit on the outside of the drill shaft coincide, the spiral-shaped connection weld facilitates the transportation of the fluid on the outside of the drill shaft.

According to the invention, the method for producing a drill shaft for a core bit is characterized in that the N, N≥1 strip materials are shaped into a spiral tube and integrally joined at the strip edges by means of N, N≥1 spiral-shaped connection welds. The method according to the invention enables the cost-effective production of a spiral-tube-shaped drill shaft for a core bit. The strip materials are continuously helically shaped into spiral tubes having a constant radius of curvature in a molding installation and welded at the strip edges in a welding installation.

In a preferred further development of the method, a seam material is used when joining the abutting strip edges of the N, N≥1 strip materials by means of the N, N≥1 spiral-shaped connection welds. The seam material may be, for example, in the form of wire, strips or powder, and produces a spiral-shaped connection weld protruding relative to the shaped strip material. Using seam material when integrally joining the abutting strip edges enables spiral-shaped connection welds to be produced that protrude relative to the shaped strip material. The protruding spiral-shaped connection welds guide the drill shaft by means of the drilled core when drilling on the inside of the drill shaft and/or by means of the drilled hole when drilling on the outside of the drill shaft. The geometry of the spiral-shaped connection welds can be influenced by means of process control during welding. The seam material can be applied to the inside of the drill shaft, to the outside of the drill shaft, or to the inside and outside of the drill shaft.

In a particularly preferred variant of the method, the seam material has a higher tensile strength, a higher wear resistance, or a higher tensile strength and wear resistance than the N, N≥1 strip materials. Using seam material that has a higher tensile strength, a higher wear resistance, or a higher tensile strength and wear resistance than the strip materials enables the properties of the spiral-shaped connection weld to be influenced so that guidance of the drill shaft by the spiral-shaped connection weld is ensured as far as possible throughout the whole lifespan of the drill shaft.

In an alternative particularly preferred variant of the method, a first seam material and a second seam material are used when joining the abutting strip edges of the N, N≥1 strip materials by means of the spiral-shaped connection welds, where the material properties of the first seam material are different from the material properties of the second seam material. The properties of the spiral-shaped connection welds can be influenced by means of the material properties of the seam material used. The first seam material can, for example, have the same material properties as the strip materials, with the result that during the welding a smooth transition is achieved between the strip edges and the first seam material binds well with the strip material. The first seam material can, for example, have a higher tensile strength, a higher wear resistance, or a higher tensile strength and wear resistance than the strip materials and improve the properties of the spiral-shaped connection welds.

Exemplary embodiments of the invention are described below with the aid of the drawings. The drawings are not necessarily intended to represent the exemplary embodiments to scale; rather, the drawings, where useful for explanatory purposes, are executed in a schematic and/or slightly distorted form. At the same time, it should be borne in mind that a wide variety of modifications and changes concerning the form and the details of an embodiment can be made without deviating from the general idea of the invention. The general idea of the invention is not limited to the exact form or the details of the preferred embodiment shown and described below or limited to subject matter that would be restricted compared with the subject matter claimed in the patent claims. Where ranges of measurements are given, values lying within the specified limits should also be considered disclosed as limit values and be able to be used and claimed at will. For the sake of simplicity, the same reference numbers are used below for identical or similar parts, or parts with an identical or a similar function.

### BRIEF DESCRIPTION OF THE DRAWINGS

FIGS. 1A, B show a first embodiment of a core bit according to the invention having a cutting portion and a spiral-tube-shaped drill shaft portion, which can be connected by means of a releasable connecting device, in the connected state (FIG. 1A) and in the non-connected state (FIG. 1B);

FIGS. 2A, B show a longitudinal section of the drill shaft portion of the first core bit of FIG. 1 along the section line A-A in FIG. 1B (FIG. 2A) as well as a detail of the drill shaft of FIG. 2A in an enlarged view (FIG. 2B);

FIG. 3 shows a second embodiment of a core bit according to the invention having a cutting portion and a spiral-tube-shaped drill shaft portion, which can be connected by means of a non-releasable connecting device;

FIGS. 4A, B show a longitudinal section of the second core bit of FIG. 3 along the section line A-A in FIG. 3 (FIG. 4A) as well as a detail of the drill shaft of FIG. 4A in an enlarged view (FIG. 4B);

FIG. 5 shows a third embodiment of a core bit according to the invention having a cutting portion and a spiral-tube-shaped drill shaft portion; and

FIGS. 6A, B show a longitudinal section of the third core bit of FIG. 5 along the section line A-A in FIG. 5 (FIG. 6A) as well as a detail of the drill shaft of FIG. 6A in an enlarged view (FIG. 6B).

### DETAILED DESCRIPTION OF THE DRAWINGS

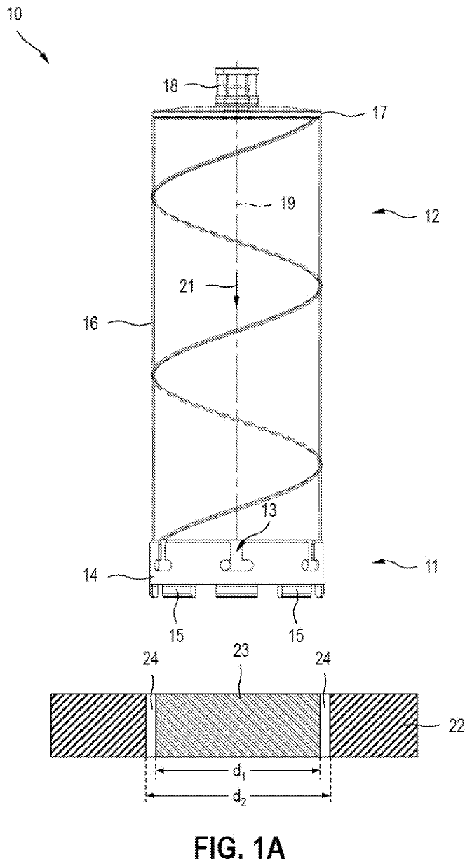

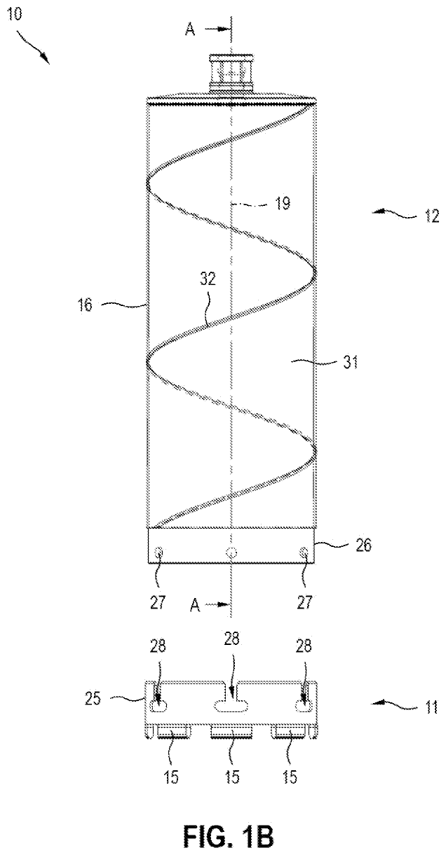

FIGS. 1A, B show a first embodiment of a core bit 10 according to the invention, which is hereinafter referred to as the first core bit 10. The first core bit 10 comprises a cutting portion 11, a drill shaft portion 12, and a connecting device 13 that releasably connects the cutting portion 11 to the drill shaft portion 12. FIG. 1A shows the first core bit 10 in the connected state and FIG. 1B shows the first core bit 10 in the non-connected state.

The cutting portion 11 comprises a ring portion 14 and a plurality of cutting segments 15 that are connected to the ring portion 14. The cutting segments 15 are arranged in a ring and form a cutting ring with intermediate spaces. Instead of a plurality of cutting segments 15, the cutting portion 11 may also have a single cutting segment configured as a closed cutting ring. The cutting segments 15 are welded, soldered or screwed to the ring portion 14 or fixed to the ring portion 14 by another suitable method of attachment. The drill shaft portion 12 comprises a spiral-tube-shaped drill shaft 16, a cover 17 and an insertion end 18, by means of which insertion end the first core bit 10 is fixed in a tool holder of a core drill. During drilling, the first core bit 10 is driven around a drilling axis 19 by the core drill and moved in a drilling direction 21 parallel to the drilling axis 19 into a workpiece 22 that is to be machined. The first core bit 10 produces a drilled core 23 having a core diameter d₁ and a drilled hole 24 having a drilled-hole diameter d₂ in the workpiece 22. The cutting segments 15 form a cutting ring having an inner diameter that corresponds to the core diameter d₁ and an outer diameter that corresponds to the drilled-hole diameter d_{z}.

The connecting device 13 is configured as a releasable connecting device in the form of a combined plug-and-pin connection and comprises a first plug connection element 25 that is connected to the ring portion 14 and a second plug connection element 26 that is connected to the drill shaft 16. The first and second plug connection elements 25, 26 form a plug connection and are additionally secured by means of a pin connection. The pin connection comprises a plurality of pin elements 27 that are inserted into T-shaped slots 28. The pin elements 27 are fixed to an outside of the second plug connection element 26 and the T-shaped slots 28 are provided in the first plug connection element 25. The cutting portion 11 can be easily and quickly connected to the drill shaft portion 12 by the user. To this end, the cutting portion 11 with the first plug connection element 25 is placed on the second plug connection element 26 of the drill shaft portion 12 in such a way that the pin elements 27 are placed in the slots 28. The cutting portion 11 is moved in the drilling direction 21 and then secured by a rotation around the drilling axis 19.

The drill shaft 16 is configured as a welded spiral tube that has been produced from a strip material 31 in the form of a flat sheet by means of shaping and welding. The flat strip material 31 has been shaped into a spiral tube and joined at the abutting strip edges by means of a spiral-shaped connection weld 32. The spiral-shaped connection weld 32 acts as a stiffening member for the drill shaft 16 and increases the stiffness of the drill shaft 16 compared to a longitudinally seam-welded or tubular drill shaft having the same wall thickness.

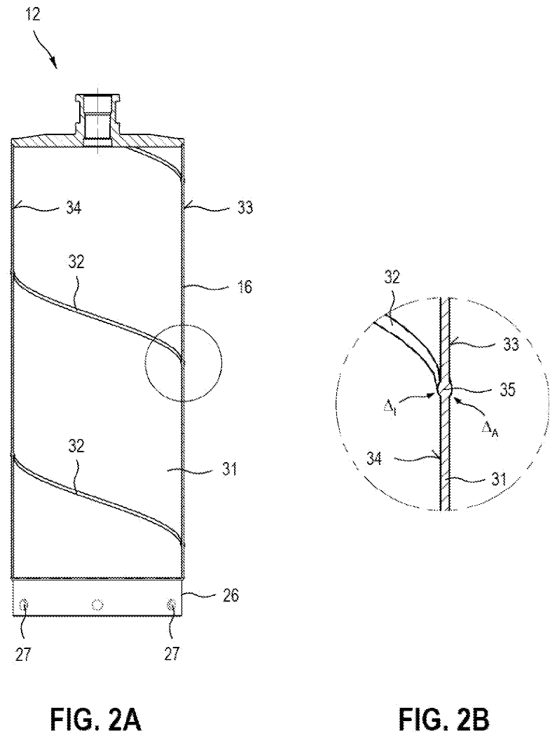

FIGS. 2A, B show a longitudinal section of the drill shaft portion 12 of the first core bit 10 of FIG. 1 along the section line A-A in FIG. 1B (FIG. 2A) as well as a detail of the drill shaft 16 of FIG. 2A in an enlarged view (FIG. 2B).

The spiral-shaped connection weld 32 protrudes relative to the shaped strip material 31 on an outside 33 and an inside 34 of the drill shaft 16. The protrusion of the spiral-shaped connection weld 32 on the outside 33 of the drill shaft 16 is referred to as outer protrusion Δ_{A} and the protrusion of the spiral-shaped connection weld 32 on the inside 34 of the drill shaft 16 is referred to as inner protrusion Δ_{I}.

In order to be able to produce a spiral-shaped connection weld 32 that protrudes relative to the shaped strip material 31 on the outside 33, the inside 34, or the outside and inside 33, 34, a seam material 35 must be used when welding the shaped strip material 31 that provides the volume of material required. The seam material can be in the form of powder, wire or strips. In addition, the material properties of the seam material 35 can be adapted to the desired properties of the spiral-shaped connection weld 32.

The spiral-shaped connection weld 32 improves the guidance of the drill shaft 16 during drilling with the first core bit 10. The smaller the gap between the spiral-shaped connection weld 32 and the borehole 24 on the outside 33 and/or between the spiral-shaped connection weld 32 and the drilled core 23 on the inside 34, the better the drill shaft 16 is guided. Friction between the spiral-shaped connection weld 32 and the borehole 24 on the outside 33 and/or between the spiral-shaped connection weld 32 and the drilled core 23 on the inside 34 may cause the spiral-shaped connection weld 32 to become worn, whereby the guidance of the drill shaft 16 is impaired. Using seam material that has a higher tensile strength and wear resistance than the strip material 31 enables the properties of the spiral-shaped connection weld 32 to be influenced so that guidance of the drill shaft 16 by the spiral-shaped connection weld 32 is ensured as far as possible throughout the whole lifespan of the drill shaft 16.

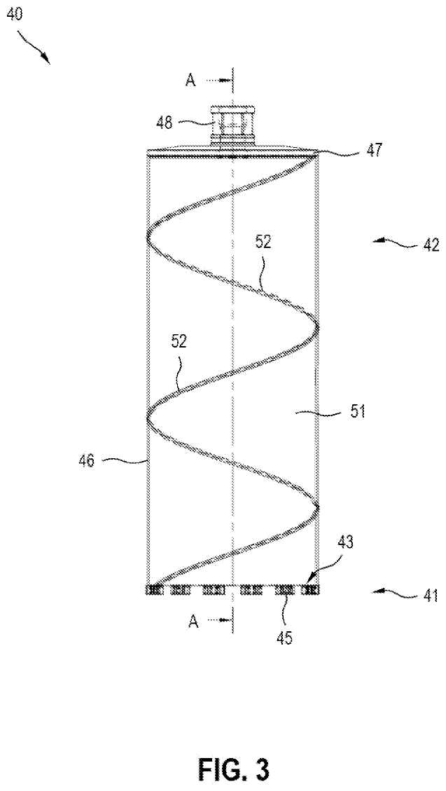

FIG. 3 shows a second embodiment of a core bit 40 according to the invention, which is hereinafter referred to as the second core bit 40. The second core bit 40 comprises a cutting portion 41, a drill shaft portion 42 and a connecting device 43 that non-releasably connects the cutting portion 41 to the drill shaft portion 42.

The cutting portion 41 comprises a plurality of cutting segments 45 that form a cutting ring having an inner diameter that corresponds to the core diameter d₁ and an outer diameter that corresponds to the drilled-hole diameter d₂. The drill shaft portion 42 comprises a spiral-tube-shaped drill shaft 46, a cover 47 and an insertion end 48, by means of which insertion end the second core bit 40 is fixed in a tool holder of a core drill. The cutting segments 15 are non-releasably connected to the drill shaft 46 by means of the connecting device 43, where the connecting device 43 is configured as a welded joint, soldered joint or bonded joint. In principle, any connecting device that non-releasably connects the cutting segments 15 and the drill shaft 46 is suitable.

The drill shaft 46 is spirally configured in the form of a welded spiral tube that has been made from a strip material 51 in the form of a flat sheet with recesses by means of shaping and welding. The strip material 51 has been shaped into a spiral tube and joined at the abutting strip edges by means of a spiral-shaped connection weld 52.

The second core bit 40 shows a cutting portion 41 with a plurality of cutting segments 45, which are non-releasably fixed to the drill shaft 46 by means of the connecting device 43. Instead of a plurality of cutting segments 45, the cutting portion 41 may also have a single cutting segment configured as a closed cutting ring. In addition, the cutting portion 41 may have a ring portion that is arranged between the cutting segments 45 and the drill shaft 46. The cutting segments 45 are welded, soldered or screwed to the ring portion or fixed to the ring portion by another suitable method of attachment, and the ring portion and the drill shaft 46 are releasably or non-releasably connected by means of a connecting device. The ring portion may, like the drill shaft 46, be configured as a spiral-tube shape. In the case of thin strip materials, however, using tubular ring portions with a constant wall thickness is recommended, since a larger contact surface is available for fixing the cutting segments 45.

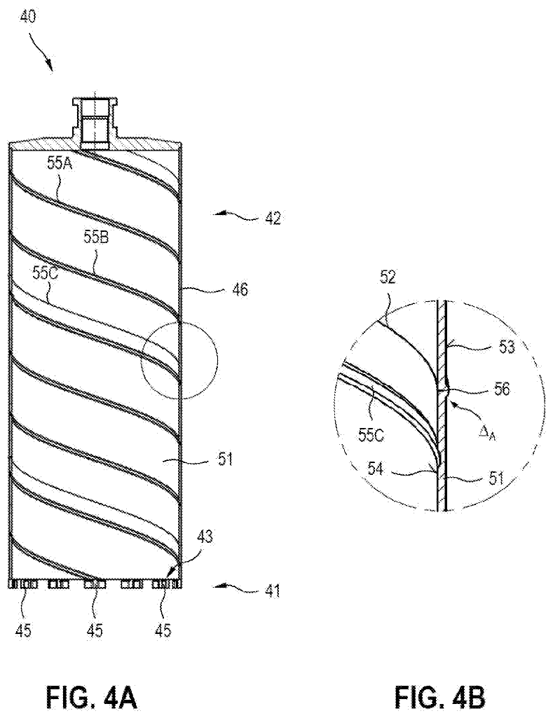

FIGS. 4A, B show a longitudinal section of the second core bit 40 of FIG. 3 along the section line A-A in FIG. 3 (FIG. 4A) as well as a detail of the drill shaft 46 of FIG. 4A in an enlarged view (FIG. 4B).

The spiral-shaped connection weld 52 of the drill shaft 46 protrudes on an outside 53 of the drill shaft 46 with an outer Δ_{A} relative to the shaped strip material 51 and is configured on an inside 54 of the drill shaft 46 to be substantially flush with the shaped strip material 51. In order to produce the spiral-shaped connection weld 52 protruding on the outside 53, a seam material 55 is used when welding the shaped strip material 51 that provides the volume of material required.

The seam material 55 can be in the form of powder, wire or strips. The properties of the spiral-shaped connection weld 52 can be adjusted by means of the material properties of the seam material 55. The seam material 55 may have the same material properties as or different material properties from the strip material 51. If seam material 55 and strip material 51 have the same material properties, this results in a smooth transition when welding the strip edges and the seam material 55 can bind well with the strip material 51. Using seam material 55 that has a higher tensile strength and/or wear resistance than the strip material 51 enables the properties of the spiral-shaped connection weld 52 to be influenced so that guidance of the drill shaft 46 by the spiral-shaped connection weld 52 is ensured as far as possible throughout the whole lifespan of the drill shaft 46.

The second core bit 40 shows a spiral-tube-shaped drill shaft 46 having a spiral-shaped connection weld 52 that protrudes on the outside 53 of the drill shaft 46 relative to the shaped strip material 51 and is configured on the inside 54 of the drill shaft 46 to be substantially flush with the shaped strip material 51. Alternatively, the spiral-shaped connection weld 52 may protrude on the inside 54 of the drill shaft 46 with an inner protrusion Δ_{I} relative to the shaped strip material 51 and be configured on the outside 53 of the drill shaft 46 to be substantially flush with the shaped strip material 51. A spiral-shaped connection weld 52 protruding on the inside 54 of the drill shaft 46 enables the drill shaft 46 to be guided by the drilled core 23 when drilling with the second core bit 40. In addition, the spiral-shaped connection weld 52 protruding on the inside 54 may facilitate the addition of clean cooling and flushing fluid during wet drilling. The spiral-shaped connection weld 52 acts as a conveyor screw for the clean cooling and flushing fluid if the direction of rotation of the second core bit 40 and the orientation of the spiral-shaped connection weld 52 on the inside 54 of the drill shaft 46 coincide.

Wet drilling with the second core bit 40 requires a cooling and flushing fluid, which, as a cooling fluid, cools the cutting segments 45 and, as a flushing fluid, removes drilling cuttings from the drilled hole 24. The spiral-shaped connection weld 52 protruding on the outside 53 of the drill shaft 46 may, in addition to guidance of the drill shaft 46 by the drilled hole 24, facilitate the removal of used cooling and flushing fluid mixed with drilling cuttings. The spiral-shaped connection weld 52 acts as a conveyor screw for the used cooling and flushing fluid mixed with drilling cuttings if the direction of rotation of the second core bit 40 and the orientation of the spiral-shaped connection weld 52 on the outside 53 of the drill shaft 46 coincide.

For the purposes of adding clean cooling and flushing fluid to the inside 54 of the drill shaft 46, three recesses 56A, 56B and 56C are arranged on the inside 54 of the drill shaft 46, which are referred to as the first recess 56A, the second recess 56B and the third recess 56C. The recesses 56A, 56B and 56C are produced in the sheet before the shaping of the strip material 51 into the spiral tube and serve as a transport channel for the necessary cooling and flushing fluid during wet drilling with the second core bit 40. The recesses 56A, 56B and 56C are particularly necessary in the case of a small inner gap between the drilled core and the drill shaft. The number of the recesses 56A, 56B and 56C, the geometry of the recesses 56A, 56B and 56C, and the placement of the recesses 56A, 56B and 56C on the outside 53 and/or the inside 54 of the drill shaft 46 can be adjusted according to the quantity of the cooling and flushing fluid.

The recesses 56A, 56B and 56C provided on the inside 54 of the drill shaft 46 are used for the addition of clean cooling and flushing fluid, and recesses provided on the outside 53 of the drill shaft 46 may facilitate the removal of used cooling and flushing fluid mixed with drilling cuttings. Since the recesses 56A, 56B and 56C for the second core bit 40 are produced before the shaping of the strip material 51, recesses can be produced on the inside 54 of the drill shaft 46 with low manufacturing costs.

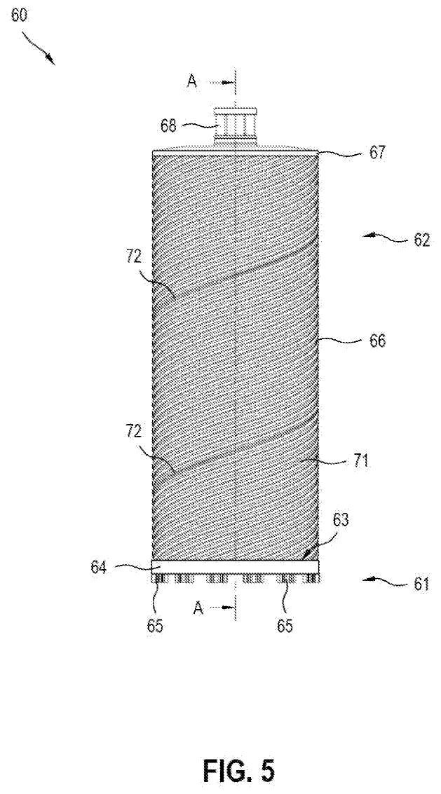

FIG. 5 shows a third embodiment of a core bit 60 according to the invention, which is hereinafter referred to as the third core bit 60. The third core bit 60 comprises a cutting portion 61, a drill-shaft portion 62 and a connecting device 63 that non-releasably connects the cutting portion 61 to the drill-shaft portion 62.

The cutting portion 61 comprises a ring portion 64 and a plurality of cutting segments 65, which are welded, soldered or screwed to the ring portion 64 or fixed to the ring portion 64 by another suitable method of attachment. The drill-shaft portion 62 comprises a spiral-tube-shaped drill shaft 66, a cover 67 and an insertion end 68, by means of which insertion end the third core bit 60 is fixed in a tool holder of a core drill.

The drill shaft 66 is configured as a welded spiral tube that has been made from a strip material 71 in the form of a corrugated profiled sheet by means of shaping and welding. The strip material 71 has been shaped into a spiral tube and joined at the abutting strip edges by means of a spiral-shaped connection weld 72. The spiral-shaped connection weld 72 acts as a stiffening member for the drill shaft 66.

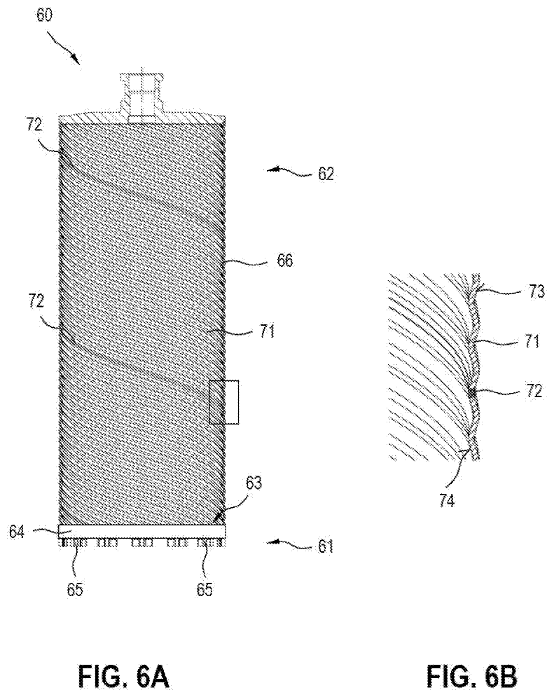

FIGS. 6A, B show a longitudinal section of the third core bit 60 of FIG. 5 along the section line A-A in FIG. 5 (FIG. 6A) as well as a detail of the drill shaft 66 of FIG. 6A in an enlarged view (FIG. 6B).

The spiral-shaped connection weld 72 of the drill shaft 66 is configured on an outside 73 of the drill shaft 66 and on an inside 74 of the drill shaft 66 to be substantially flush with the shaped strip material 71. The profiled cross-section of the strip material 71 creates recesses on the outside 73 and the inside 74 of the drill shaft 66, by means of which the cooling and flushing fluid can be transported when wet drilling with the third core bit 60. The recesses provided on the inside 74 of the drill shaft 66 are used for the addition of clean cooling and flushing fluid and the recesses provided on the outside 73 of the drill shaft 66 are used for the removal of used cooling and flushing fluid mixed with drilling cuttings. The geometry of the profiled sheet can be adjusted according to the quantity of fluid needed for wet drilling.

1.-16. (canceled)

17. A core bit for producing a borehole having a borehole diameter and a drilled core having a core diameter in a workpiece, comprising:
a cutting portion with at least one cutting segment which forms a cutting ring having an inner diameter that corresponds to the core diameter and an outer diameter that corresponds to the borehole diameter;
a drill shaft portion with a tubular drill shaft; and
a connecting device that connects the cutting portion and the drill-shaft portion together releasably or non-releasably;
wherein the tubular drill shaft is configured as a welded spiral tube.

18. The core bit according to claim 17, wherein the tubular drill shaft is shaped from N, wherein N≥1, strip materials and wherein respective strip edges of the strip materials are integrally joined by N, wherein N≥1, spiral-shaped connection welds.

19. The core bit according to claim 18, wherein the strip materials are configured as flat sheets having a constant sheet thickness.

20. The core bit according to claim 18, wherein the strip materials are configured as flat sheets having at least one recess.

21. The core bit according to claim 18, wherein the strip materials are configured as profiled sheets with a profiled cross-section and wherein the profiled sheets have a sheet thickness and a profiled height.

22. The core bit according to claim 18, wherein at least one of the spiral-shaped connection welds protrudes relative to the strip materials and wherein the at least one of the spiral-shaped connection welds contains a seam material.

23. The core bit according to claim 22, wherein the seam material and the strip materials have same material properties.

24. The core bit according to claim 22, wherein the seam material and the strip materials have different material properties.

25. The core bit according to claim 24, wherein the seam material has a higher tensile strength and/or a higher wear resistance than the strip materials.

26. The core bit according to claim 22, wherein the at least one of the spiral-shaped connection welds protrudes on an inside of the tubular drill shaft with an inner protrusion relative to the strip materials.

27. The core bit according to claim 22, wherein the at least one of the spiral-shaped connection welds protrudes on an outside of the tubular drill shaft with an outer protrusion relative to the strip materials.

28. The core bit according to claim 22, wherein the at least one of the spiral-shaped connection welds protrudes on an inside of the tubular drill shaft with an inner protrusion relative to the strip materials and on an outside of the tubular drill shaft with an outer protrusion relative to the strip materials.

29. A method for producing the tubular drill shaft for the core bit according to claim 17, wherein N, wherein N≥1, strip materials are shaped into a spiral tube and are integrally joined at respective abutting strip edges by N, wherein N≥1, spiral-shaped connection welds.

30. The method according to claim 29, wherein a seam material is used when integrally joining the respective abutting strip edges.

31. The method according to claim 30, wherein the seam material has a higher tensile strength and/or a higher wear resistance than the strip materials.

32. The method according to claim 29, wherein when integrally joining the respective abutting strip edges a first seam material and a second seam material are used, wherein material properties of the first seam material are different from material properties of the second seam material.
